(19) United States
(12) Patent Application Publication
(10) Pub. No.: US 2017/0059855 A1
(43) Pub. Date: Mar. 2, 2017

(54) ELECTRONIC DEVICE, IMAGE DISPLAY DEVICE, AND HEAD MOUNTED DISPLAY

(71) Applicant: Seiko Epson Corporation, Tokyo (JP)

(72) Inventor: Hirokazu YAMAGA, Chino (JP)

(21) Appl. No.: 15/246,731

(22) Filed: Aug. 25, 2016

(30) Foreign Application Priority Data
Sep. 2, 2015 (JP) 2015-172604

(51) Int. Cl. G02B 26/10; H02N 2/04; H02K 41/035; G02B 26/08; G02B 27/01

(52) U.S. Cl. CPC G02B 26/101; G02B 26/085; G02B 27/0172; H02K 41/0356; H02N 2/04

(57) ABSTRACT

An electronic device includes an optical scanner main body provided with a vibration system, a substrate on which the optical scanner main body is mounted, and a flexible substrate connected to the substrate. The substrate includes a part on which the optical scanner main body is mounted, a part to which the flexible substrate is connected, and a notch which separates the parts from each other at least at a part between the parts in a plan view when the substrate is viewed from the thickness direction.

### BACKGROUND

1. Technical Field

The present invention relates to an electronic device, an image display device, and a head mounted display.

2. Related Art

An electronic device which is made as a module by connecting a flexible wiring substrate (FPC) to a substrate on which a structure having a vibration system is loaded (for example, refer to JP-A-2015-106597), is known.

For example, the module according to JP-A-2015-106597 includes a base (substrate), a micro electro mechanical system (MEMS) mirror loaded on the base, and an FPC connected to the base.

In the module according to JP-A-2015-106597 described above, there is a problem that stress generated in the base when an external force is applied to the FPC is transmitted to the MEMS mirror, and characteristics of the MEMS mirror, such as resonance frequency or amplitude, change.

### SUMMARY

An advantage of some aspects of the invention is to provide an electronic device which can reduce a change in characteristics of a vibration system even when an external force is applied to a flexible substrate connected to a substrate on which a vibration structure having the vibration system is loaded, and an image display device and a head mounted display which are provided with the electronic device.

The advantage can be achieved by the following configurations.

An electronic device according to an aspect of the invention includes: a vibration structure; a substrate on which a vibration structure is mounted; and a flexible substrate which is connected to the substrate, in which the substrate includes a first part on which the vibration structure is mounted, a second part to which the flexible substrate is bonded, and a separation portion which separates the first part and the second part from each other between the first part and the second part in a plan view when viewed from the thickness direction of the substrate.

According to the electronic device, even when the external force is applied to the flexible substrate and stress is generated in the substrate, it is possible to suppress or reduce transmission of the stress from the second part to the first part by the separation portion. As a result, it is possible to reduce variation of characteristics of the vibration system of the vibration structure, such as resonance frequency or amplitude, caused by the influence of the stress.

In addition, by connecting the flexible substrate to the substrate on which the vibration structure is mounted, that is, by connecting the vibration structure and the flexible substrate to one substrate, in a state before installing the substrate on a base or the like, it is possible to easily form the wiring which electrically connects the vibration structure and the flexible substrate to each other by using wire bonding.

In the electronic device according to the aspect of the invention, it is preferable that the substrate includes a third part at which the first part and the second part are connected to each other.

With this configuration, it is possible to shorten the distance between the first part and the second part, and further, it is possible to shorten the distance between the vibration structure and the flexible substrate. Therefore, it becomes easy to electrically connect the vibration structure and the flexible substrate to each other. In addition, it is possible to shorten the length of the wiring which connects the vibration structure and the flexible substrate to each other, and to reduce noise incorporated into the wiring.

In the electronic device according to the aspect of the invention, it is preferable that the separation portion is a notch formed on the substrate.

With this configuration, compared to a case where the separation portion is not a notch, it is possible to form the separation portion in a comparatively simple manner.

In the electronic device according to the aspect of the invention, it is preferable that the notch is opened on a side surface of the substrate.

With this configuration, it is possible to effectively reduce transmission of the stress from the second part to the first part.

In the electronic device according to the aspect of the invention, it is preferable that a base which supports the substrate by the third part is further provided.

With this configuration, it is possible to stably support the substrate, and to effectively reduce transmission of the stress from the second part to the first part.

In the electronic device according to the aspect of the invention, it is preferable that the substrate has rigidity which is higher than that of the flexible substrate.

With this configuration, it becomes easy to install (wire) the flexible substrate, and when the external force is applied to the flexible substrate, it is possible to absorb the external force by the flexible substrate, and to reduce the stress generated in the substrate.

In the electronic device according to the aspect of the invention, it is preferable that a wire which is disposed to overlap the separation portion in a plan view, and connects the vibration structure and the flexible substrate to each other is further provided.

With this configuration, while reducing the stress generated between the vibration structure and the flexible substrate, it is possible to easily electrically connect the vibration structure and the flexible substrate to each other.

In the electronic device according to the aspect of the invention, it is preferable that the vibration structure includes an output portion which outputs a signal that corresponds to a vibration state of a vibration system, and the flexible substrate is electrically connected to the output portion.

Since the signal from the output portion to the flexible substrate is weak, the signal is likely to be influenced by the noise. Therefore, from the viewpoint of reducing the noise incorporated into the signal, it is preferable to shorten the distance between the vibration structure and the flexible substrate as much as possible. In this case, even when the distance between the vibration structure and the flexible substrate is shortened, when the external force is applied to the flexible substrate, it is possible to reduce transmission of the stress generated in the substrate to the vibration structure. Therefore, it becomes possible to detect the vibration state of the vibration system with high accuracy, and to drive the vibration system with high accuracy based on the detection result.

In the electronic device according to the aspect of the invention, it is preferable that the vibration structure includes a movable portion, a fixed portion which is fixed to the substrate, and a shaft portion which connects the movable portion and the fixed portion to be capable of rotating the movable portion.

With this configuration, it is possible to realize an optical device, such as an optical scanner.

In the electronic device according to the aspect of the invention, it is preferable that a driving portion which rotates the movable portion by using an electromagnetic force is further provided, and the substrate is configured of a non-magnetic material.

With this configuration, it is possible to effectively rotate the movable portion by using an electromagnetic force.

An image display device according to another aspect of the invention includes the electronic device according to the aspect of the invention.

According to the image display device, since the electronic device has stable characteristics, it is possible to achieve excellent reliability.

A head mounted display according to still another aspect of the invention includes the electronic device according to the aspect of the invention.

According to the head mounted display, since the electronic device has stable characteristics, it is possible to achieve excellent reliability.

### BRIEF DESCRIPTION OF THE DRAWINGS

The invention will be described with reference to the accompanying drawings, wherein like numbers reference like elements.

FIG. 1 is a perspective view illustrating an electronic device (optical scanner module) according to an embodiment.

FIG. 2 is a plan view (a view from the +Z-axis direction side) of the electronic device illustrated in FIG. 1.

FIG. 3 is a front view (a view from the +Y-axis direction side) of the electronic device illustrated in FIG. 1.

FIG. 4 is a view schematically illustrating an embodiment of an image display device.

FIG. 5 is a perspective view illustrating an application example 1 of the image display device.

FIG. 6 is a perspective view illustrating an application example 2 of the image display device.

FIG. 7 is a perspective view illustrating an application example 3 of the image display device.

### DESCRIPTION OF EXEMPLARY EMBODIMENTS

Hereinafter, an appropriate embodiment of the electronic device, an image display device, and a head mounted display, will be described with reference to the attached drawings. In addition, hereinafter, an example of a case where a vibration structure included in the electronic device is an optical scanner main body, will be described.

### 1. Electronic Device (Optical Scanner Module)

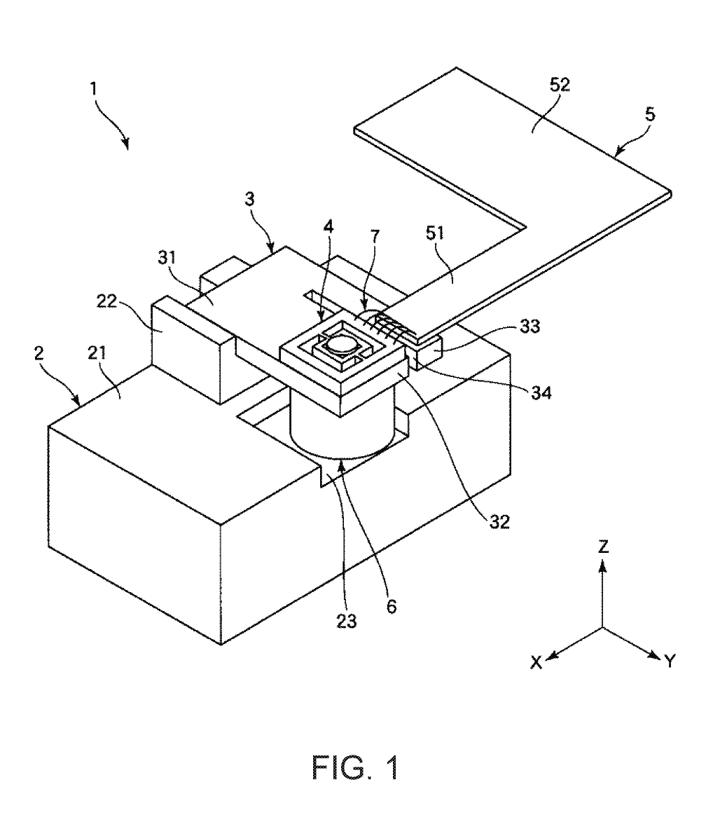

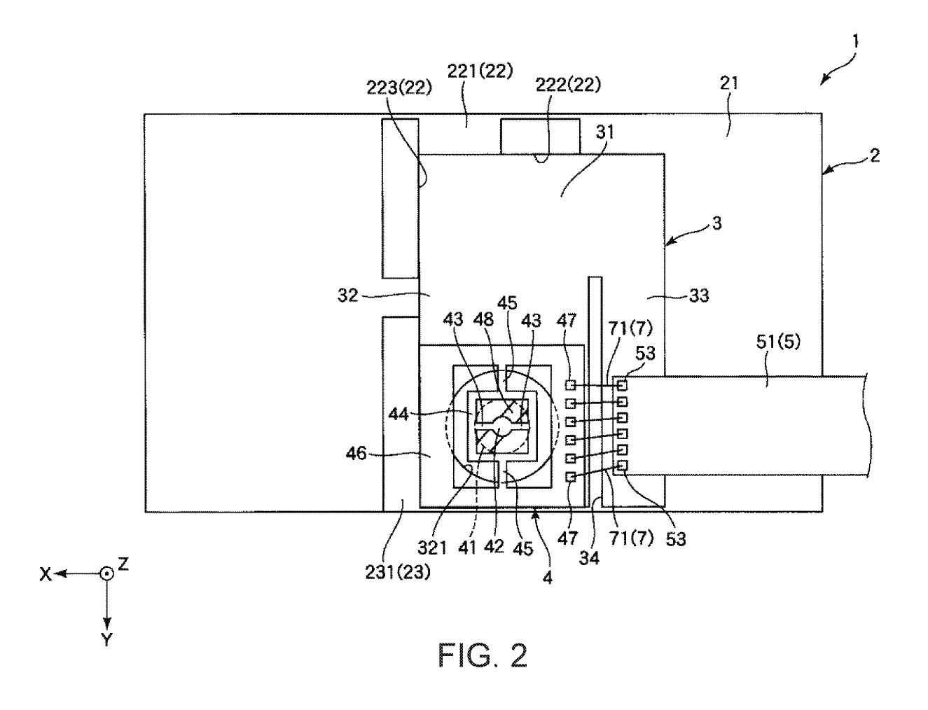

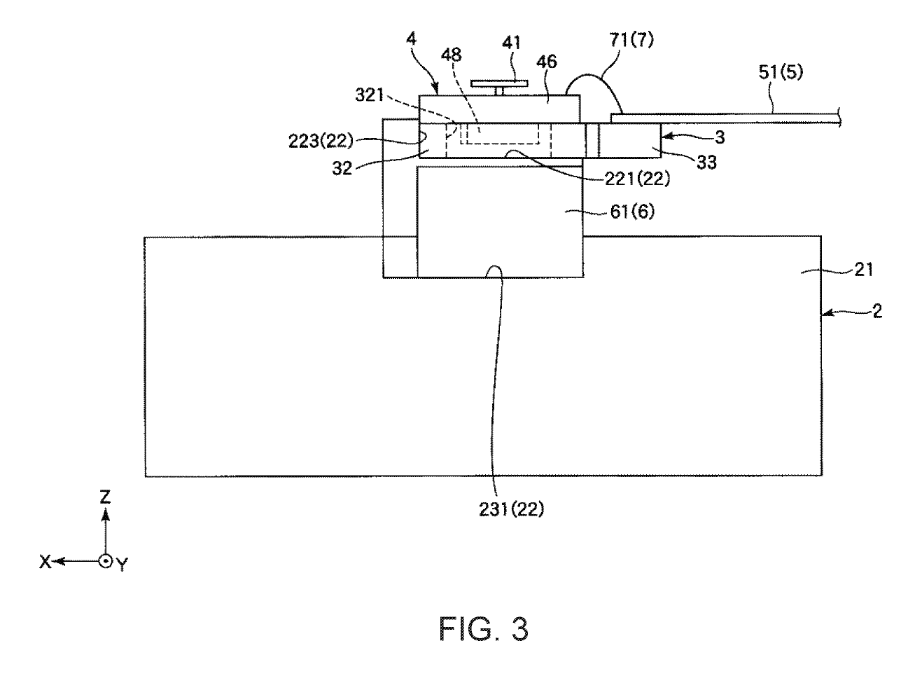

FIG. 1 is a perspective view illustrating the electronic device (optical scanner module) according to an embodiment. FIG. 2 is a plan view (a view from the +Z-axis direction side) of the electronic device illustrated in FIG. 1. FIG. 3 is a front view (a view from the +Y-axis direction side) of the electronic device illustrated in FIG. 1.

In addition, in each drawing, for convenience of description, three axes, such as the X-axis, the Y-axis, and the Z-axis, which are orthogonal to each other, are respectively illustrated by arrows in one direction, and a tip end side of each arrow is “+”, and a base end side is “−”. In addition, the direction parallel to the X-axis is the “X-axis direction”, the direction parallel to the Y-axis is the “Y-axis direction”, and the direction parallel to the Z-axis is the “Z-axis direction”. In addition, the +Z-axis direction side is the “upper side”, and the −Z-axis direction side is the “lower side”. In addition, a surface parallel to a plane including the X-axis and the Y-axis is an “XY plane”, a surface parallel to a plane including the X-axis and the Z-axis is an “XZ plane”, and a surface parallel to a plane including the Y-axis and the Z-axis is a “YZ plane”.

An electronic device 1 is an optical scanner module. The electronic device 1 includes a base 2, a substrate 3 supported by the base 2, an optical scanner main body 4 (vibration structure) loaded on the substrate 3, a flexible substrate 5 connected to the substrate 3, a wiring portion 7 which connects the optical scanner main body 4 and the flexible substrate 5 to each other, and a magnetic field generating portion 6 for driving which is attached to the base 2.

Hereinafter, each portion of the electronic device 1 will be described in order.

### Base

The base 2 has a function of supporting the substrate 3 and the magnetic field generating portion 6. The base 2 includes a main body 21, and a substrate supporting portion 22 and a magnetic field generating portion supporting portion 23 which are provided on an upper surface of the main body 21.

The main body 21 has a shape of a block which is flat along the XY plane. The main body 21 is used to be fixed to an apparatus in which the electronic device 1 is assembled. A fixing method thereof is not particularly limited, but examples thereof include a fixing method using a screw and a fixing method using an adhesive.

The substrate supporting portion 22 has a function of supporting the substrate 3. The substrate supporting portion 22 is provided to protrude at a position biased to the −Y-axis direction side in the center portion in the X-axis direction of the upper surface of the main body 21. Above the substrate supporting portion 22, as illustrated in FIG. 2 or 3, an installation surface 221 along the XY plane toward the upper side, an abutting surface 222 along the XZ plane toward the installation surface 221 side, and an abutting surface 223 along the YZ plane toward the installation surface 221 side are formed.

The magnetic field generating portion supporting portion 23 has a function of supporting the magnetic field generating portion 6. The magnetic field generating portion supporting portion 23 is provided on the +Y-axis direction side with respect to the substrate supporting portion 22 on the upper surface of the main body 21. In the embodiment, the magnetic field generating portion supporting portion 23 is provided at a position biased to the +Y-axis direction side in the center position in the X-axis direction of the upper surface of the main body 21. In addition, the magnetic field generating portion supporting portion 23 is configured of a recessed portion formed on the upper surface of the main body 21, and a bottom surface of the recessed portion becomes an installation surface 231. In addition, the installation surface 231 is appropriately set to have a height which corresponds to the height of the installation surface 221 of the substrate supporting portion 22, and not being limited to the above-described configuration, for example, the installation surface 231 may be provided in a projected portion formed on the upper surface of the main body 21.

It is preferable that the base 2 is a substantially rigid body. Accordingly, it is possible to suppress or reduce twist of the base 2 due to the external force and negative influence of the external force on the substrate 3 or the optical scanner main body 4.

In addition, in the embodiment, it is preferable that the base 2 has characteristics of making the magnetism pass therethrough. Accordingly, it is possible to drive the optical scanner main body 4 by effectively using the magnetic field from the magnetic field generating portion 6. From this point of view, it is preferable that a non-magnetic material is used as the material which configures the base 2, but specifically, the material is not particularly limited. Examples thereof include: a metal material, such as copper (Cu), SUS304, aluminum (Al), titanium (Ti), magnesium (Mg), and Hestelloy; a ceramics material; a resin material; or a glass material. In addition, in a case where the driving type of the optical scanner main body 4 is a method other than an electromagnetic driving method, for example, an electrostatic driving method or a piezoelectric driving method, the base 2 may not have characteristics of making the magnetism pass therethrough. In this case, a configuration material of the base 2 may be a magnetic material.

### Substrate

The substrate 3 is supported to be fixed to the substrate supporting portion 22 of the above-described base 2. The fixing method thereof is not particularly limited, but examples thereof include a fixing method using a screw and a fixing method using an adhesive.

The substrate 3 is installed to have a shape of a plate, and to make one surface (lower surface) thereof along the installation surface 221 of the substrate supporting portion 22. Accordingly, it is possible to stably install the substrate 3 in a state of being along the XY plane. In addition, the substrate 3 is installed in a state where a side surface of the substrate 3 abuts against each of the abutting surfaces 222 and 223 of the substrate supporting portion 22. Accordingly, it is possible to position the substrate 3 with high accuracy in the X-axis direction and in the Y-axis direction. In addition, it is also possible to regulate a change in the posture within the XY plane of the substrate 3.

In particular, as illustrated in FIG. 2, the substrate 3 includes a part 31 (third part) fixed to the substrate supporting portion 22, and a part 32 (first part) and a part 33 (second part) which extend from the part 31 in the +Y-axis direction. The substrate 3 including the parts 31, 32, and 33 is formed by providing a notch 34 (separation portion) which extends along the Y-axis direction and is opened to the +Y-axis direction side of the substrate 3.

Here, the length of the part 31 in the Y-axis direction is substantially equivalent to the length of the installation surface 221 of the substrate supporting portion 22 in the Y-axis direction. In addition, the length of the part 31 in the X-axis direction is longer than the length of the installation surface 221 in the X-axis direction. In addition, an end portion of the part 31 on the −X-axis direction side is positioned on the −X-axis direction side (outer side in a plan view) with respect to the installation surface 221.

The part 32 is positioned on the +Y-axis direction side (outer side in a plan view) with respect to the installation surface 221. Accordingly, the part 32 becomes separated from the base 2 (more specifically, the upper surface of the main body 21), and has a part of opposing the installation surface 231 of the base 2. In the embodiment, in the part 32, a through hole 321 which suppresses or reduces contact with a magnet 48 or the like of the above-described optical scanner main body 4.

The part 33 is positioned on the −X-axis direction side and on the +Y-axis direction side (outer side in a plan view) with respect to the installation surface 221. Accordingly, the part 33 becomes separated from the base 2 (more specifically, the upper surface of the main body 21). In addition, the part 33 makes a longitudinal shape which extends along the Y-axis direction. Accordingly, even when an external force is applied to the part 33, it is possible to more effectively absorb the external force by modification of the part 33, and to suppress or reduce negative influence on the part 32.

It is preferable that the substrate 3 has characteristics of making the magnetism pass therethrough. Accordingly, it is possible to drive the optical scanner main body 4 by effectively using the magnetic field from the magnetic field generating portion 6. From this point of view, it is preferable that a non-magnetic material is used as the material which configures the substrate 3, but specifically, the material is not particularly limited. Examples thereof include: a metal material, such as copper (Cu), SUS304, aluminum (Al), titanium (Ti), magnesium (Mg), and Hestelloy; a ceramics material; a resin material; or a glass material. In addition, from the viewpoint of shortening the distance between the optical scanner main body 4 and the magnetic field generating portion 6 and effectively operating the magnetic field from the magnetic field generating portion 6 in the optical scanner main body 4, the substrate 3 which is made as thin as possible is preferable. In addition, in a case where the driving type of the optical scanner main body 4 is a method other than an electromagnetic driving method, for example, an electrostatic driving method or a piezoelectric driving method, the base 2 may not have characteristics of making the magnetism pass therethrough. In this case, a configuration material of the substrate 3 may be a magnetic material.

### Optical Scanner Main Body

The optical scanner main body 4 (vibration structure) is mounted on the upper surface of the part 32 (first part) of the above-described substrate 3. The optical scanner main body 4 includes alight reflecting plate 41, a base portion 42 which supports the light reflecting plate 41, one pair of shaft portions 43 which supports the base portion 42 to be rotatable, a frame body portion 44 which supports the one pair of shaft portions 43, one pair of shaft portions 45 which supports the frame body portion 44 to be rotatable, a fixing portion 46 which supports the one pair of shaft portions 45, a plurality of terminals 47 provided in the fixing portion 46, and a magnet 48 provided in the frame body portion 44.

The optical scanner main body 4 includes a vibration system which is made as a mass (movable portion) configured of the light reflecting plate 41, the base portion 42, the one pair of shaft portions 43, the frame body portion 44, and the magnet 48 is supported by the one pair of shaft portions 45 to be oscillatable (reciprocable). The vibration system includes a vibration system which is made as a mass (movable portion) configured of the light reflecting plate 41 and the base portion 42 is supported by the one pair of shaft portions 43 to be oscillatable. In this manner, the optical scanner main body 4 is a “vibration structure” including the vibration system.

A light reflecting film (not illustrated) having light reflexibility is provided on the upper surface (one surface) of the light reflecting plate 41. The light reflecting film is, for example, configured of a metal film, such as aluminum.

The light reflecting plate 41 is provided to be separated from one pair of shaft portions 43 in the plate thickness direction of the light reflecting plate 41, and to overlap a part of one pair of shaft portions 43 in a plan view. Accordingly, even when increasing the area of a plate surface of the light reflecting plate 41, it is possible to reduce the size of the optical scanner main body 4.

Here, the lower surface (the other surface) of the light reflecting plate 41 has a protruded part, and the part is joined to the base portion 42. Accordingly, it is possible to suppress or reduce the contact of the light reflecting plate 41 with the shaft portion 43 or the frame body portion 44. In addition, a joining method of the light reflecting plate 41 and the base portion 42 is not particularly limited, but an example thereof includes a solid joining method, such as a joining method using an adhesive or a surface activating joining surface.

In this manner, the base portion 42 to which the light reflecting plate 41 is fixed is supported by the frame body portion 44 via one pair of shaft portions 43. One pair of shaft portions 43 connects the base portion 42 and the frame body portion 44 to each other so as to make the base portion 42 oscillatable (rotatable) around a first shaft parallel to the X-axis. The frame body portion 44 is provided to make a shape of a frame, and to surround the base portion 42, in a plan view. The thickness of the frame body portion 44 becomes thicker than the thicknesses of each of the shaft portions 43 and 45 to protrude to a lower side with respect to each of the shaft portions 43 and 45. Accordingly, it is possible to improve rigidity of the frame body portion 44, and to suppress or reduce the contact of the base portion 42 or the shaft portion 43 with the magnet 48.

The frame body portion 44 is supported by the fixing portion 46 via one pair of shaft portions 45. One pair of shaft portions 45 connects the frame body portion 44 and the fixing portion 46 to each other so as to make the frame body portion 44 oscillatable (rotatable) around a second shaft parallel to the Y-axis. The fixing portion 46 is provided to make a shape of a frame, and to surround the frame body portion 44, in a plan view. In addition, the fixing portion 46 is fixed to the substrate 3 by an adhesive or the like.

In addition, the magnet 48 is joined to the lower surface (a surface opposite to the light reflecting plate 41) of the frame body portion 44. The joining method is not particularly limited, but an example thereof can include a joining method using an adhesive.

The magnet 48 is magnetized in the direction inclined to the first shaft and the second shaft which are the above-described two oscillation center shafts. Appropriate examples of the magnet 48 can include a neodymium magnet, a ferrite magnet, a samarium-cobalt magnet, an alnico magnet, and a bond magnet.

In addition, as illustrated in FIG. 2, a plurality of terminals 47 are provided at apart on the −X-axis direction side of the upper surface of the fixing portion 46. At least two of the plurality of terminals 47 are electrically connected to a piezo resistance element (not illustrated) provided on the shaft portion 43 or the shaft portion 45. Therefore, at least two of the plurality of terminals 47 configure an “output portion” which outputs a signal which corresponds to a vibration state of the vibration system included in the optical scanner main body 4. In addition, the terminal other than the output portion in the plurality of terminals 47 is not particularly limited, but for example, in a case where the piezo resistance element is a four-terminal type, the terminal can be used in inputting the signal for applying an electric field to a piezo resistance region of the piezo resistance element. In addition, the number of terminals 47 is decided corresponding to the number or configuration of the piezo resistance element used in the optical scanner main body 4, and is not limited to that in the drawing.

In the optical scanner main body 4 configured as described above, the base portion 42, one pair of shaft portions 43, the frame body portion 44, one pair of shaft portions 45, and the fixing portion 46 are integrally formed by performing the processing by etching a substrate, such as a silicon substrate or an SOI substrate. In addition, the light reflecting plate 41 is also formed by performing the processing by etching a substrate, such as a silicon substrate or an SOI substrate.

The optical scanner main body 4 configured as described above can realize an optical device, such as an optical scanner.

### Flexible Substrate

The flexible substrate 5 has a long shape, and one end portion thereof is connected (joined) to the upper surface of the part 33 (second part) of the above-described substrate 3. In the embodiment, the flexible substrate 5 has a substantial L shape in a plan view. The flexible substrate 5 includes a part 51 which extends along the X-axis direction, and a part 52 which extends along the Y-axis direction from the part 51, and an end portion (one end portion) opposite to the part 52 of the part 51 is connected (bonded) to the part 33 of the substrate 3.

In addition, the flexible substrate 5 is, for example, a flexible printed board (FPC), and as illustrated in FIG. 2, a plurality of terminals 53 which are electrically connected to a wiring (not illustrated) included in the flexible substrate 5 are provided on the upper surface of one end portion of the flexible substrate 5. The plurality of terminals 53 are provided corresponding to the plurality of terminals 47 of the above-described optical scanner main body 4.

### Wiring Portion

The wiring portion 7 is connected to the above-described optical scanner main body 4 and the flexible substrate 5. More specifically, the wiring portion 7 includes a plurality of wires 71 (wiring) which are electrically connected to each of the plurality of terminals 47 of the above-described optical scanner main body 4, and the plurality of terminals 53 of the flexible substrate 5.

Each wire 71 is formed, for example, by wire bonding.

### Magnetic Field Generating Portion

The magnetic field generating portion 6 is supported by the magnetic field generating portion supporting portion of the above-described base 2. The magnetic field generating portion 6 configures a “driving portion” which drives the light reflecting plate 41 by using the electromagnetic force together with the magnet 48 of the above-described optical scanner main body.

As illustrated in FIG. 3, the magnetic field generating portion 6 includes a coil 61. The coil 61 is fixed to the installation surface 231 of the magnetic field generating portion supporting portion 23 in a state where the shaft line thereof is disposed along the Z-axis direction. The fixing method thereof is not particularly limited, but an example thereof includes a fixing method using an adhesive. In addition, the magnetic field generating portion 6 includes a core provided in the coil 61.

The magnetic field generating portion 6 is positioned immediately below the magnet 48 of the above-described optical scanner main body 4. Accordingly, it is possible to make the magnetic field generated from the magnetic field generating portion 6 effectively act on the magnet 48.

The magnetic field generating portion 6 (coil 61) is electrically connected a voltage applying portion which is not illustrated. In addition, as the voltage is applied to the magnetic field generating portion 6 by the voltage applying portion, a magnetic field in the Z-axis direction is generated from the magnetic field generating portion 6 with respect to the magnet 48. More specifically, the voltage applying portion superposes first voltage of a first frequency for rotating the light reflecting plate 41 around the first shaft, and second voltage of a second frequency for rotating the light reflecting plate 41 around the second shaft, and applies the superposed voltage to the magnetic field generating portion 6. Accordingly, the light reflecting plate 41 can rotate around the first shaft at the first frequency, and rotate around the second shaft at the second frequency.

A behavior (vibration state) of the light reflecting plate 41 is detected by the piezo resistance element (not illustrated) provided at least in one shaft portion among the shaft portion 43 and the shaft portion 45. In addition, the driving of the voltage applying portion is suppressed based on the detection result.

According to the electronic device 1 described above, since the notch 34 (separation portion) separates the part 32 and the part 33 from each other at at least a part between the part 32 and the part 33 in a plan view when viewed from the thickness direction of the substrate 3, even when the external force is applied to the flexible substrate 5 and stress is generated in the substrate 3, it is possible to further suppress or reduce transmission of the stress from the part 33 to the part 32 by the notch 34. As a result, it is possible to reduce variation of characteristics of the vibration system of the optical scanner main body 4, such as resonance frequency or amplitude, caused by the influence of the stress.

In addition, by connecting the flexible substrate 5 to the substrate 3 on which the optical scanner main body 4 is mounted, that is, by connecting the optical scanner main body 4 and the flexible substrate 5 to one substrate 3, in a state before installing the substrate 3 on the base 2 or the like, it is possible to easily form the wiring portion 7 which electrically connects the optical scanner main body 4 and the flexible substrate 5 to each other by using the wire bonding.

In addition, the substrate 3 is provided with the part 31 which connects the part 32 and the part 33 to each other, and the part 32 and the part 33 extend to the same side to each other from the part 31. In other words, the substrate 3 configures a substantial U shape (recessed shape) in a plan view when the substrate 3 is viewed from the thickness direction, and the notch 34 becomes a recessed portion. Accordingly, it is possible to shorten the distance between the part 32 and the part 33, and further to shorten the distance between the optical scanner main body 4 and the flexible substrate 5. Therefore, it becomes easy to electrically connect the optical scanner main body 4 and the flexible substrate 5 to each other. In addition, it is possible to shorten the length of the wiring portion 7 which connects the optical scanner main body 4 and the flexible substrate 5 to each other, and to reduce noise incorporated into the wiring portion 7.

In addition, as the separation portion which separates the part 32 and the part 33 from each other is the notch 34 formed on the substrate 3, it is possible to form the separation portion in a comparatively simple manner.

Furthermore, the notch 34 is opened on the side opposite to the part 31. In other words, the notch 34 is opened on the side surface of the substrate 3. In addition, the side surface is a surface which intersects a surface on which the flexible substrate 5 or the optical scanner main body 4 of the substrate 3 is disposed. Accordingly, it is possible to effectively reduce transmission of the stress from the part 33 to the part 32.

In addition, since the base 2 supports the substrate 3 by the part 31, and since the part 31 functions as a substantially rigid body, it is possible to stably support the substrate 3, and to effectively reduce transmission of the stress from the part 33 to the part 32.

In addition, the substrate 3 has higher rigidity than that of the flexible substrate 5. Accordingly, it becomes easy to install (wire) the flexible substrate 5, and when the external force is applied to the flexible substrate 5, it is possible to absorb the external force by the flexible substrate 5, and to reduce the stress generated in the substrate 3.

In addition, each wire 71 of the wiring portion 7 which connects the optical scanner main body 4 and the flexible substrate 5 to each other is disposed to overlap the notch 34 in a plan view. Accordingly, it is possible to reduce the stress generated between the optical scanner main body 4 and the flexible substrate 5, and to easily electrically connect the optical scanner main body 4 and the flexible substrate 5 to each other.

In addition, as described above, the flexible substrate 5 is electrically connected to the terminal 47 (output portion) which outputs the signal that corresponds to the vibration state of the vibration system of the optical scanner main body 4. Since the signal from the terminal 47 to the flexible substrate 5 is weak, the signal is likely to be influenced by the noise. Therefore, from the viewpoint of reducing the noise incorporated into the signal, it is preferable to shorten the distance between the optical scanner main body 4 and the flexible substrate 5 as short as possible. In this case, even when the distance between the optical scanner main body 4 and the flexible substrate 5 is shortened, when the external force is applied to the flexible substrate 5, it is possible to reduce transmission of the stress generated in the substrate 3 to the optical scanner main body 4. Therefore, it becomes possible to detect the vibration state of the vibration system with high accuracy, and to drive the vibration system with high accuracy based on the detection result.

### 2. Image Display Device

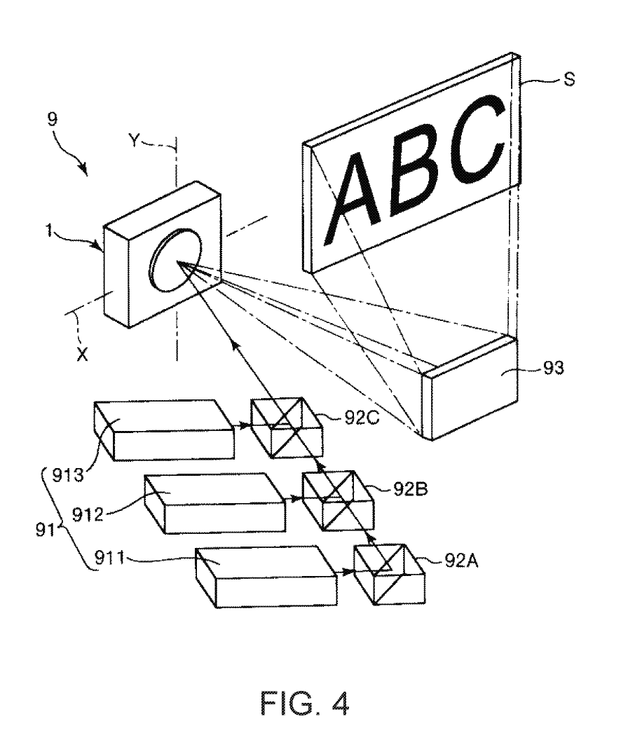

FIG. 4 is a view schematically illustrating an embodiment of the image display device.

In the embodiment, as an example of the image display device, a case where the electronic device 1 is used as an optical scanner of a display for imaging, will be described. In addition, the longitudinal direction of a screen S is the “horizontal direction”, and the direction perpendicular to the longitudinal direction is the “vertical direction”. In addition, the X-axis is parallel to the horizontal direction of the screen S, and the Y-axis is parallel to the vertical direction of the screen S. In addition, FIG. 4 schematically illustrates the electronic device 1.

An image display device (projector) 9 includes a light source device (light source) 91 which emits light, such as laser, a plurality of dichroic mirrors 92A, 92B, and 92C, and the electronic device 1.

The light source device 91 includes a red light source device 911 which emits red light, a blue light source device 912 which emits blue right, and a green light source device 913 which emits green light.

Each of the dichroic mirrors 92A, 92B, and 92C is an optical element which synthesizes light emitted from each of the red light source device 911, the blue light source device 912, and the green light source device 913.

Based on image information from a host computer which is not illustrated, the image display device 9 is configured to synthesize the light emitted from the light source device 91 (red light source device 911, blue light source device 912, green light source device 913) by each of the dichroic mirrors 92A, 92B, and 92C, two-dimensionally scan the synthesized light by the electronic device 1, and forma color image on the screen S.

During the two-dimensional scanning, the light reflected by the light reflecting plate 41 is scanned (main scanning) in the horizontal direction of the screen S by the rotation of the light reflecting plate 41 of the electronic device 1 around the Y-axis. Meanwhile, the light reflected by the light reflecting plate 41 is scanned (main scanning) in the longitudinal direction of the screen S by the rotation of the light reflecting plate 41 of the electronic device 1 around the X-axis.

In addition, in FIG. 4, after two-dimensionally scanning the light synthesized by the dichroic mirrors 92A, 92B, and 92C by the electronic device 1, an image is formed on the screen S after reflecting the light by the extending portion 93. However, the extending portion 93 may be omitted, and the light which is two-dimensionally scanned by the electronic device 1 may be directly emitted to the screen S.

Hereinafter, application examples of the image display device will be described.

### Application Example 1 of Image Display Device

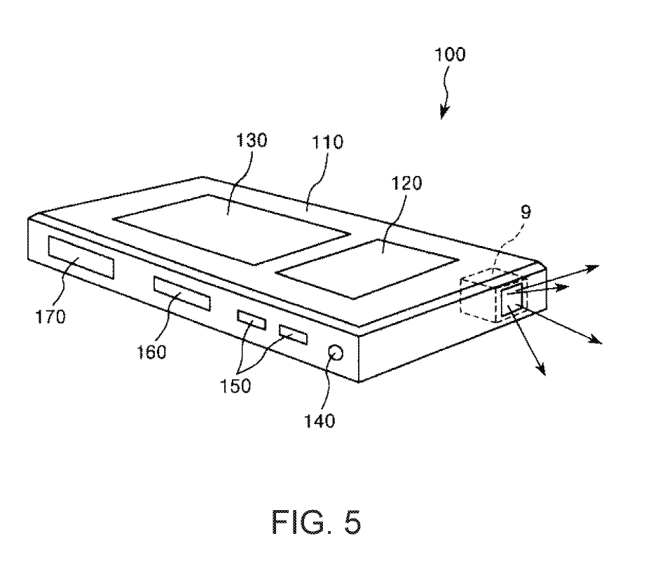

FIG. 5 is a perspective view illustrating an application example 1 of the image display device.

As illustrated in FIG. 5, the image display device 9 can be employed in a portable image display device 100.

The portable image display device 100 includes a casing 110 formed by dimensions which make it possible to grip the device by hand, and the image display device 9 embedded in the casing 110. It is possible to display a predetermined image on a predetermined surface, such as a screen or a desk, by the portable image display device 100.

In addition, the portable image display device 100 includes a display 120 which displays predetermined information, a keyboard 130, an audio port 140, a control button 150, a card slot 160, and an AV port 170.

In addition, the portable image display device 100 may have other functions, such as a call function or a GPS receiving function.

### Application Example 2 of Image Display Device

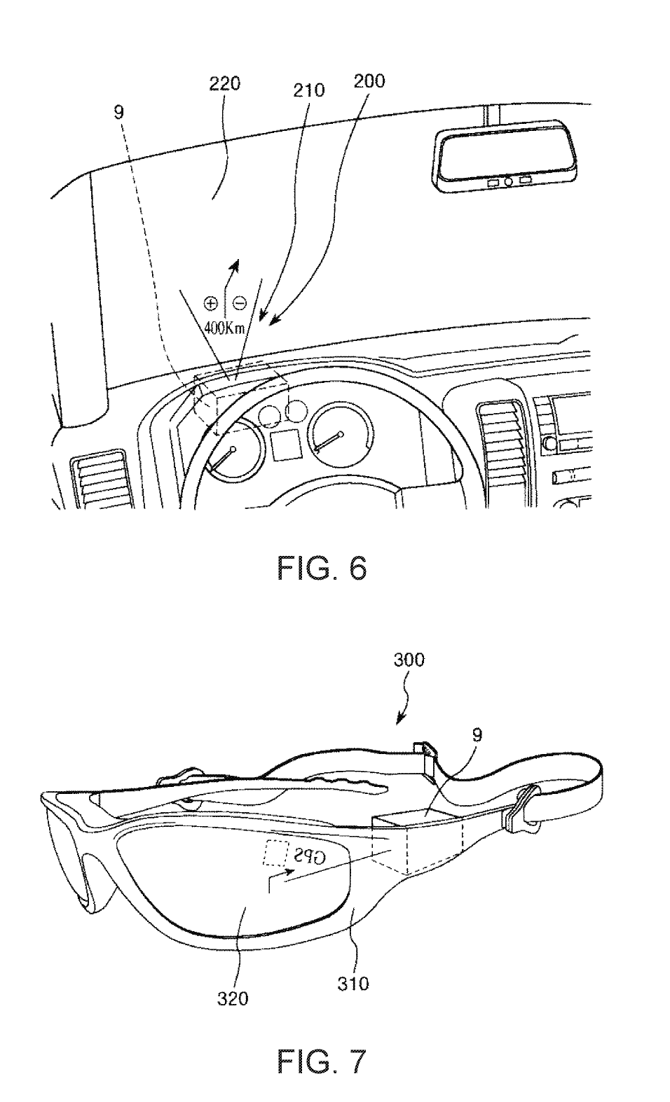

FIG. 6 is a perspective view illustrating an application example 2 of the image display device.

As illustrated in FIG. 6, the image display device 9 can be employed in a head-up display system 200.

In the head-up display system 200, the image display device 9 is loaded on a dashboard of a vehicle to configure a head-up display 210. It is possible to display a predetermined image, such as a guide sign to the destination, on a front glass 220 by the head-up display 210.

In addition, not being limited to the vehicle, the head-up display system 200 can also be employed, for example, in an airplane or a ship.

### Application Example 3 of Image Display Device

FIG. 7 is a perspective view illustrating an application example 3 of the image display device.

As illustrated in FIG. 7, the image display device 9 can be employed in a head mounted display 300.

In other words, the head mounted display 300 includes glasses 310 and the image display device 9 loaded on the glasses 310. In addition, a predetermined image which is visually recognized by one eye is displayed on a display portion 320 provided at a part of the glasses 310 corresponding a lens in normal glasses, by the image display device 9.

The display portion 320 may be transparent, or may be opaque. In a case where the display portion 320 is transparent, it is possible use the display portion 320 by uploading information from the image display device 9 on information from real world.

In addition, two image display devices 9 are provided in the head mounted display 300, and the image which is visually recognized by both eyes may be displayed on two display portions.

Above, the electronic device, the image display device, and the head-mounted display are described based on the embodiments illustrated in the drawings, but the invention is not limited thereto. For example, configurations of each portion can be replaced with an arbitrary configuration having similar functions, and another arbitrary configuration can be added.

In addition, in the above-described embodiment, a case where the optical scanner main body of a moving magnet method is used, is described as an example, but the driving method of the optical scanner main body is not limited thereto, and examples thereof may include another electromagnetic driving method, such as a moving coil method, a piezoelectric driving method, or an electrostatic driving method.

In addition, in the above-described embodiment, a case where two-shaft type optical scanner main body is used as the vibration structure is described as an example, but the structure of the optical scanner main body is not limited thereto, and for example, one-shaft type or a cantilever type may be employed.

In addition, in the above-described embodiment, a case where the vibration structure of the electronic device is an optical scanner main body, is described as an example. However, the vibration structure is not limited thereto as long as a vibration system which requires vibration of a desirable number of resonance frequency or amplitude is provided. Examples thereof include a vibration piece included in a quartz crystal resonator, or an element piece included in a gyro sensor or an acceleration sensor, other than the optical scanner main body.

The entire disclosure of Japanese Patent Application No. 2015-172604, filed Sep. 2, 2015 is expressly incorporated by reference herein.

What is claimed is:

1. An electronic device comprising:
a vibration structure;
a substrate on which the vibration structure is mounted; and
a flexible substrate which is connected to the substrate,
wherein the substrate includes a first part on which the vibration structure is mounted, a second part to which the flexible substrate is bonded, and a separation portion which separates the first part and the second part from each other between the first part and the second part in a plan view when viewed from the thickness direction of the substrate.

2. The electronic device according to claim 1,
wherein the substrate includes a third part at which the first part and the second part are connected to each other.

3. The electronic device according to claim 1,
wherein the separation portion is a notch formed on the substrate.

4. The electronic device according to claim 3,
wherein the notch is opened on a side surface of the substrate.

5. The electronic device according to claim 2, further comprising:
a base which supports the substrate by the third part.

6. The electronic device according to claim 1,
wherein the substrate has rigidity which is higher than that of the flexible substrate.

7. The electronic device according to claim 1, further comprising:
a wire which is disposed to overlap the separation portion in a plan view, and connects the vibration structure and the flexible substrate to each other.

8. The electronic device according to claim 1,
wherein the vibration structure includes an output portion which outputs a signal that corresponds to a vibration state of a vibration system, and
wherein the flexible substrate is electrically connected to the output portion.

9. The electronic device according to claim 1,
wherein the vibration structure includes a movable portion, a fixed portion which is fixed to the substrate, and a shaft portion which connects the movable portion and the fixed portion to be capable of rotating the movable portion.

10. The electronic device according to claim 9, further comprising:
a driving portion which rotates the movable portion by using an electromagnetic force,
wherein the substrate is configured of a non-magnetic material.

11. An image display device comprising:
the electronic device according to claim 1.

12. An image display device comprising:
the electronic device according to claim 2.

13. An image display device comprising:
the electronic device according to claim 3.

14. An image display device comprising:
the electronic device according to claim 4.

15. An image display device comprising:
the electronic device according to claim 5.

16. A head mounted display comprising:
the electronic device according to claim 1.

17. A head mounted display comprising:
the electronic device according to claim 2.

18. A head mounted display comprising:
the electronic device according to claim 3.

19. A head mounted display comprising:
the electronic device according to claim 4.

20. A head mounted display comprising:
the electronic device according to claim 5.
